(19) United States
(12) Patent Application Publication
(10) Pub. No.: US 2014/0158005 A1
(43) Pub. Date: Jun. 12, 2014

(54) FORCED ENERGY CURED INK DELIVERY IN A PRINTING UNIT

(71) Applicant: Goss International Americas, Inc., Durham, NH (US)

(72) Inventors: Mehmet Oktay Kaya, Hampton, NH (US); Brian Robert Elkinson, Barrington, NH (US); Glenn Alan Guaraldi, Kingston, NH (US)

(73) Assignee: Goss International Americas, Inc., Durham, NH (US)

(21) Appl. No.: 14/096,260

(22) Filed: Dec. 4, 2013

Related U.S. Application Data
(60) Provisional application No. 61/734,718, filed on Dec. 7, 2012.

(51) Int. Cl. B41F 31/08

(52) U.S. Cl. CPC B41F 31/08
USPC 101/366; 101/483

(57) ABSTRACT

An ink delivery system includes a closed or closable ink container holding an ink supply. The ink container ink has an inlet and outlet. The inlet and outlet are arranged in the ink container to hold pressurized air when the ink container is closed and partially filled with ink. An air delivery system supplies pressurized air to the ink container via the inlet. A pump is connected to the outlet of the ink container, the pump receiving ink from the ink container; and an ink fountain receives ink from the pump. Preferably, the ink is ultraviolet or electron beam ink.

This application claims priority to U.S. Provisional Patent Application No. 61/734,718 filed Dec. 7, 2012, the entire disclosure of which is hereby incorporated by reference.

The present invention relates generally to printing presses and more particularly to delivery of ultraviolet and electron beam inks in a printing unit.

### BACKGROUND

Ultraviolet ink is a type of radiation-curing ink that dries, or “sets,” with the application of ultraviolet light. UV curing ink vehicles are composed of fluid oligomers (small polymers), monomers (light-weight molecules that bind together to form polymers), and photo initiators that, when exposed to ultraviolet radiation, release free radicals (extremely reactive atoms or molecules that can destabilize other atoms or molecules and start rapid chain reactions) that cause the polymerization of the vehicle, which hardens to a dry ink film containing the pigment. However, UV curing inks are as much as three times the cost of regular heatset inks, and are used only in specialty printing, such as liquor cartons, cosmetic packaging, metal decoration, screen printing, and flexography.

Electron beam ink is a printing ink that is dried with the use of electron beams. Similar to UV inks, which are cured by ultraviolet light, EB inks are cured by means of polymerization, which is made possible by the direct effect of the electrons on polymerizable substances. Unlike UV inks, special photo initiators are not required for EB inks and as a result EB inks are easier to store. The special advantage of EB inks is, however, the thickness of the layers that can be applied, as the electron beams penetrate deeply.

EB and UV curing inks are designed to replace heatset inks whose solvents emit potentially toxic and environmentally unsound gaseous emissions. The expense of UV curing inks is obviated by EB curing inks, as the reactive materials used in UV inks are very expensive. EB curing inks can utilize less expensive and less reactive materials, and do not require costly photo initiators. The real expense involved in EB curing inks is the cost of equipping a press to utilize them. There is also a danger of EB-curing equipment producing X-rays. The equipment for electron-beam curing is either a scanned beam generator (electrons are produced from a cathode and shot at a positively-charged screen, which uses a magnetic lens to focus them to a thin beam), or a linear cathode beam generator (producing electrons from a cathode but not focusing them into a beam, merely allowing them to bombard the wet ink in a shower. The latter type is the more popular, as it is smaller and more effectively shielded against X-ray leakage.

### BRIEF SUMMARY OF THE INVENTION

In printing presses, ultraviolet and electron beam ink is conventionally delivered into ink fountains by hand or with expensive and complex high pressure delivery systems, for example, high pressure pneumatic, hydraulic or diaphragm type pumps.

Ultraviolet and electron beam inks are viscous materials and do not flow freely. They do not flow as well as heatset inks. The viscous ink is difficult to siphon by a pump. Additionally, because ultraviolet and electron beam inks are energy cured, the inks tend to harden in conventional delivery systems. Handling of ultraviolet or electron beam inks with high pressure causes unintentional curing due to increased heat and friction at high pressures.

Filling ink fountains by hand at high printing speeds with heavy coverages can be costly due to the required labor. Ink levels also need to be checked throughout a production run, even during normal print jobs. In the case of high pressure delivery systems, costs of the systems and maintenance costs are high. When ink colors in the inking units need to be changed, emptying and cleaning the delivery systems for a new color is often difficult and time consuming.

The present invention provides an ink delivery system comprising:
an ink container holding an ink supply, the ink container ink having an inlet and outlet;
an air delivery system supplying pressurized air to the ink container via the inlet;
a pump connected to the outlet of the ink container, the pump receiving ink from the ink container;
an ink fountain receiving ink from the pump.

The present invention also provides a method for delivering ink comprising the steps of:
supplying ink in a closed container;
pressurizing air in the closed container so the ink flows into a pump; and
pumping the ink into an ink fountain.

The present invention further provides a printing press having the ink delivery system in accordance with the present invention.

In accordance with a first embodiment of the present invention, an ink delivery system comprises a closed or closable ink container holding an ink supply. The ink container ink has an inlet and outlet. The inlet and outlet are arranged in the ink container to hold pressurized air when the ink container is closed and partially filled with ink. An air delivery system supplying pressurized air to the ink container via the inlet. A pump is connected to the outlet of the ink container, the pump receiving ink from the ink container; and an ink fountain receives ink from the pump. Preferably, the ink is ultraviolet or electron beam ink.

In accordance with a further aspect of this embodiment, the outlet is below a level of the ink when the ink container is partially filled with ink, and the inlet is above the level of the ink when the ink container is partially filled with ink.

In accordance with another and/or further aspect of this embodiment, the ink is ultraviolet or electron beam ink, and the pressurized air is a low pressure air of from about 5 PSI (pounds per square inch) to a maximum pressure, the maximum pressure being less than a pressure at which the ink cures. Preferably, the low pressure air is from 7 to 10 PSI.

In accordance with another and/or further aspect of this embodiment, the pump is a peristaltic pump. The peristaltic pump may include a peristaltic tube and a driven rotor. The driven rotor may rotate at from about 5 to about 60 rotations per minute.

In accordance with another and/or further aspect of this embodiment the pump, which may be a peristaltic pump, is connected to the ink fountain via a delivery tube and the delivery tube has an inner diameter of from about 10 to about 30 millimeters.

In accordance with a second embodiment of the present invention, a method for delivering ink is provided which comprises the steps of: supplying ultraviolet or electron beam ink in a closed container, the closed container having an outlet below a level of the ink in the container, the closed container having a pressurized air inlet above the level of the ink; pressurizing air in the closed container via the inlet so the ink flows into a pump; and pumping the ink into an ink fountain.

In accordance with a further aspect of the second embodiment, the air is pressurized to a pressure which is from about 5 PSI, to a maximum pressure, the maximum pressure being less than a pressure at which the ink cures. Preferably, the pressure is from 7 to 10 PSI.

In accordance with another and/or further aspect of the second embodiment, the step of pumping includes pumping with a peristaltic pump. Preferably, the peristaltic pump includes a peristaltic tube and a driven rotor, and the method further comprises rotating the rotating at from about 5 to about 60 rotations per minute.

In accordance with another and/or further aspect of the second embodiment, the step of pumping, which may include pumping with the peristaltic pump or pumping with some other apparatus, includes pumping the ink to the ink fountain via a delivery tube having an inner diameter of from about 10 to about 30 millimeters.

### BRIEF DESCRIPTION OF THE DRAWINGS

A preferred embodiment of the present invention will be elucidated with reference to the drawings, in which:

FIGS. 1(A)-1(C) show a first style prior art open cup filled with ultraviolet or electron beam inks at three points in time;

FIGS. 2(A)-2(C) show a second style prior art open cup filled with ultraviolet or electron beam inks at three points in time;

FIGS. 3(A)-3(C) show a first style pressurized, closed container in accordance with an embodiment of the present invention;

FIGS. 4(A)-4(C) show a second style pressurized, closed container in accordance with an embodiment of the present invention;

FIGS. 5 and 6 show an ink delivery system according to an embodiment of the present invention.

FIG. 7 shows a web offset, perfecting printing press including an inking apparatus having an ink delivery in accordance with an embodiment of the present invention

### DETAILED DESCRIPTION OF PREFERRED EMBODIMENTS

UV, EB, and other energy cured inks present challenges for ink delivery because the forces applied to the ink during delivery in conventional ink delivery systems tend to cure the UV and EB inks prior to the inks being applied to the ink train of the printing unit. This can cause a series of problems from ink that is too viscous when it is applied to the ink train, to hardening of the ink in the ink lines of the ink delivery system.

For example, many conventional ink metering systems transmit the ink under pressure to through, for example, an ink rail system. Examples of such arrangements are described in U.S. Pat. No. 5,472,324 and U.S. 2006/0162597, incorporated herein by reference.

It is also known in the art to use a displacement pump in an ink barrel in order to deliver ink to an ink metering device or to an ink tray. However, these displacement pumps act by applying pressure, for example, via a piston, to the ink to drive it out of the ink barrel. The energy applied by the piston to the in the barrel, however, has the tendency to cause the UV, EB or other energy cured ink to harden, making displacement pump systems disadvantageous.

Another solution known in the art is to store the ink in a pressurized container, wherein the pressurized medium expels the ink from the container. However, again the energy applied by the pressurized medium as the tendency to cause the UV, EB or other energy cured ink to harden, making such systems disadvantageous.

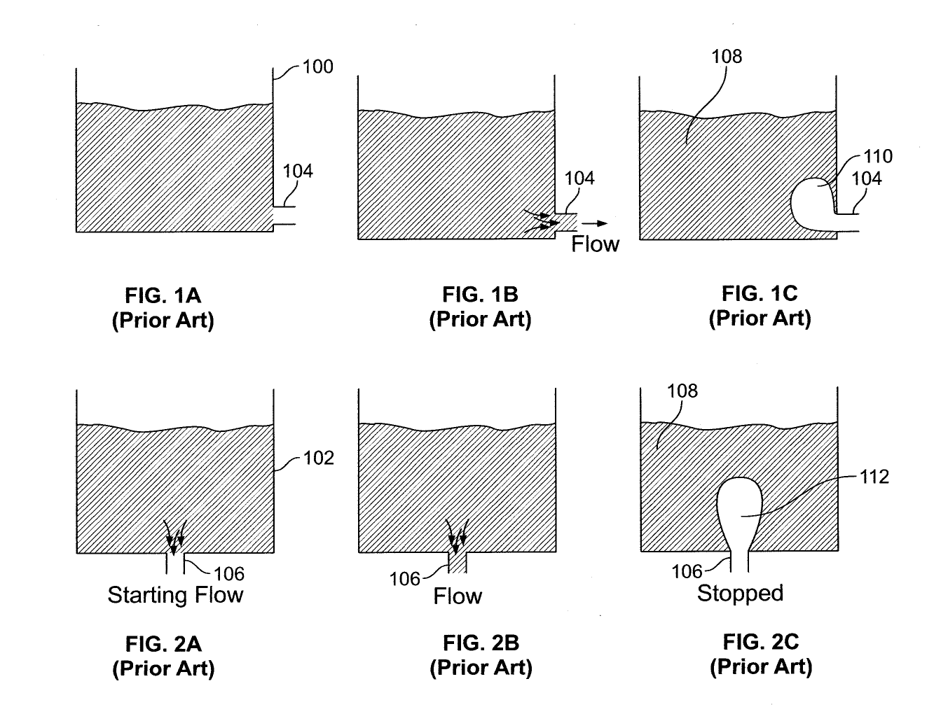

FIGS. 1 and 2 shows two different style ink cups as known in the art which are not pressurized. FIG. 1 illustrates an open air ink cup 100 having a side outlet 104 at three different times: when ink flow begins (FIG. 1A), while ink flow continues (FIG. 1B), and when ink flow stops due to the formation of air voids (FIG. 1C). FIGS. 2A, 2B, and 2C illustrate the same for open air ink cups 102 having a bottom outlet 106. Cups 100, 102 may be filled with ultraviolet ink or electron beam ink. Outlets 104, 106 are connected to a vacuum side of a pump. Ink 108 flows toward the low pressure outlet 104, 106 until a void or cavity 110, 112 is created due to the low viscosity of ink 108. Since the voids 110, 112 cannot be filled quickly; ink 108 is not able to flow into the pumps causing delay in the ink delivery.

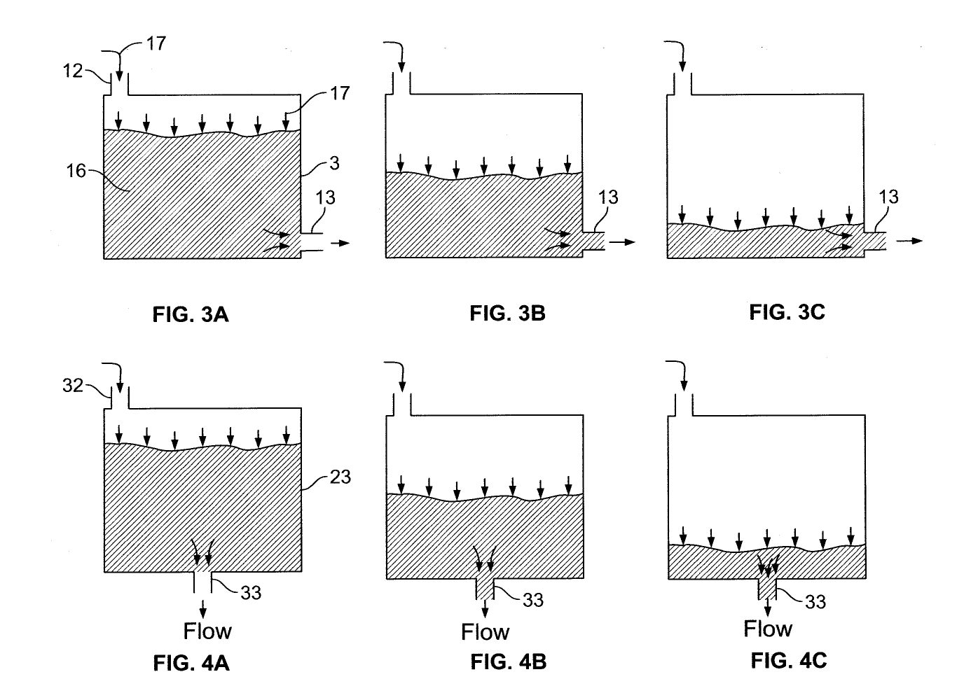

FIGS. 3(A-C) and 4(A-C) show a closeable or closed ink container 3, 23 in accordance with an embodiment of the present invention at the same three times. FIG. 2(A-C) shows a closed or closable ink container 3 with a side outlet 13, and FIG. 3(A-C) shows a closed or closable ink container 23 with a bottom outlet 33. Ink containers 3, 23 store ink 16, for example, ultraviolet or electron beam ink. Each container 3, 23 includes an inlet 12, 32, and an outlet 13, 33, respectively. Low pressurized air 17, for example, air ranging in pressure from 7 to 10 PSI, is supplied to each container 3, 23 via inlet 12, 32. The ink 16 then flows out of outlets 13, 33, respectively to a pump downstream because the pressurized air 17 helps mobilize the viscous ink 16.

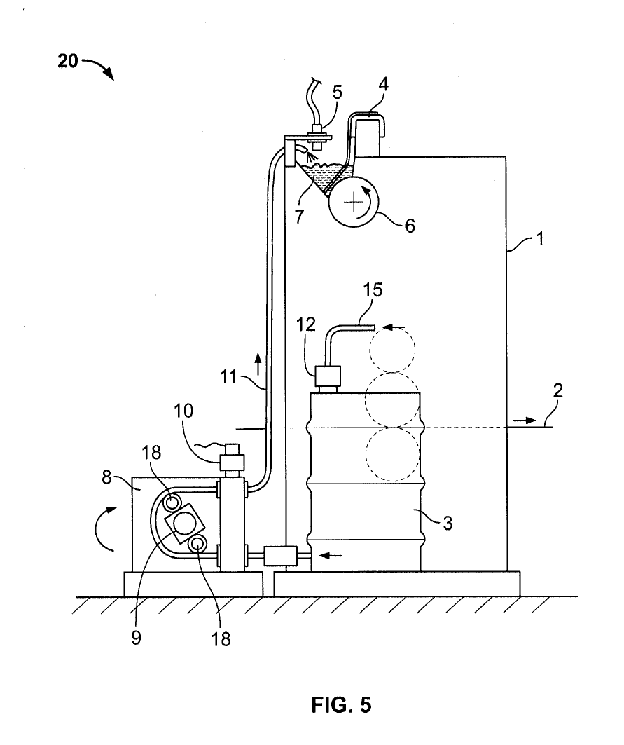

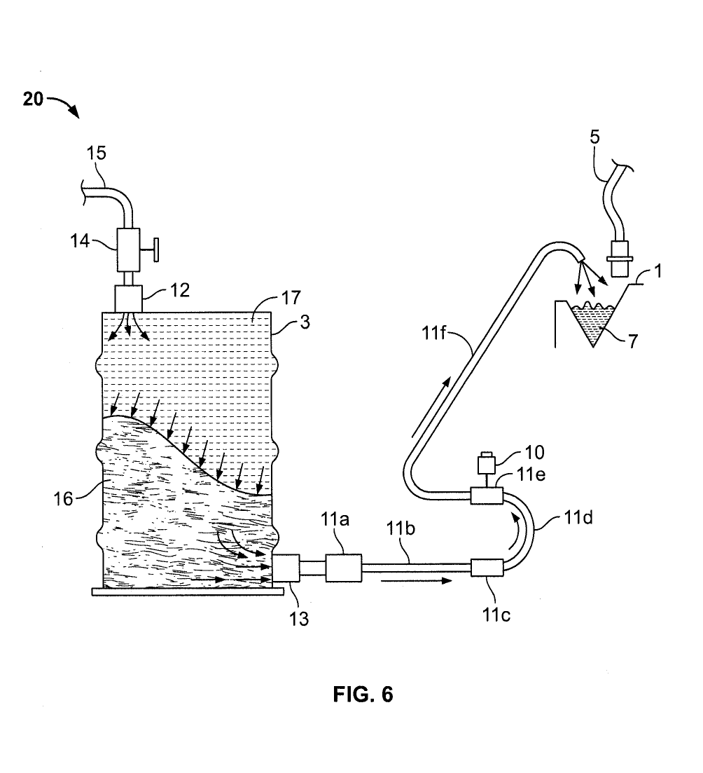

FIGS. 5 and 6 show an ink delivery system 20 for use with a printing unit 1 in accordance with an embodiment of the present invention. As shown, a pressurized air delivery system including components 14 and 15 provides pressurized air 17 to inlet 12. Components 14 and 15 may include a pressurized air delivery and a gauge or valve 14 for controlling the amount of and pressure in pressurized air 17.

As discussed above closed containers 3 include an inlet 12 and an outlet 13. Closed container 3 may be the barrel or receptacle used for transporting the ink 16 from an ink manufacturer to a printing press facility. Outlet 13 is connected to a peristaltic pump 8 via a quick connection 11a and transport tubing 11b. Pressurized air 17 forces ink 16 to mobilize and move towards outlet 13 into pump 8. Peristaltic pump is controlled such that the pressurized air 17 maintains a substantially constant pressure against the top surface 16.1 of ink 16 as the ink 16 exits through outlet 13 under the force of gravity. This substantially constant pressure thereby prevents for the formation of air bubbles, but does not import so much force (and thus energy) that the energy cured ink cures. Preferably, the pressurized air 17 has a pressure that is at least 5 PSI and less than a pressure which would cause the energy cured ink to cure. This upper limit can be empirically determined for different inks and different configurations of container 23. However, as an example, for UV or EB inks, peristaltic pump could be configured to maintain pressures air 17 in the range of 7 to 10 PSI.

Peristaltic pump 8 includes a driven rotor 9 which includes two rollers 18. Pump 8 works by rotating rotor 9. As rotor 9 rotates, rollers 18 squeeze a portion of peristaltic tubing 11d thereby creating a vacuum inside tubing 11d. This squeezing action forces viscous ink 16 to move downstream and pushes ink towards the pump outlet, chamber 11e.

Since the low pressurized air 17 helps mobilize ink 16, the ink 16 flows in to peristaltic tubing 11d. The ink 16 and tubing 11d are sealed by rollers 18 and ink 16 is pushed forward by the rotation and squeezing action of rotor 9 and rollers 18. As a result, ink 16 is delivered to the outlet chamber 11e. A number of rotations of rotor 9 is low, for example, from 5 to 60 rpm, and preferably about 8 rpm and peristaltic tube 11d includes an oversized inner diameter, for example at least 10 mm preferably for about 20 to about 30 mm, thereby minimizing heat and pressure which could otherwise set the ultraviolet or electron beam ink 16.

A pressure transducer 10 may be provided to measure pressure in the pump outlet at chamber 11e. The pressure measurement may protect the ink delivery system 20 from overload and/or monitor breakage in peristaltic tube 11d.

A delivery tube 11f is connected to chamber 11e. Ink is delivered from the pump 8 via chamber 11e to delivery tube 11f for transport to ink fountain 7. Ink fountain may be for example, an open air ink fountain. An end point of delivery tube 11f may be open or attached to a reciprocating agitator unit 4 or in a fixed cartridge. A level of ink in ink fountain 7 may be controlled by multiple or a single level sensor 5. The ink flows from the ink fountain 7 to roller 6 of the ink roller train in a conventional manner.

When an ink color change is desired, a new ink container may be connected to pump 8 and the tubing 11 (11a to 11f) may be changed. The tubing 11 may be a single piece of tubing and taken out of system 20 as one piece and replaced with a new or existing tubing assembly. By only having to change the tubing, previous complications with cleaning and delivery may be avoided or reduced. Only a short piece of tubing has to be cleaned or replaced. Thus, changing from one color ink to another may be easy, fast and clean.

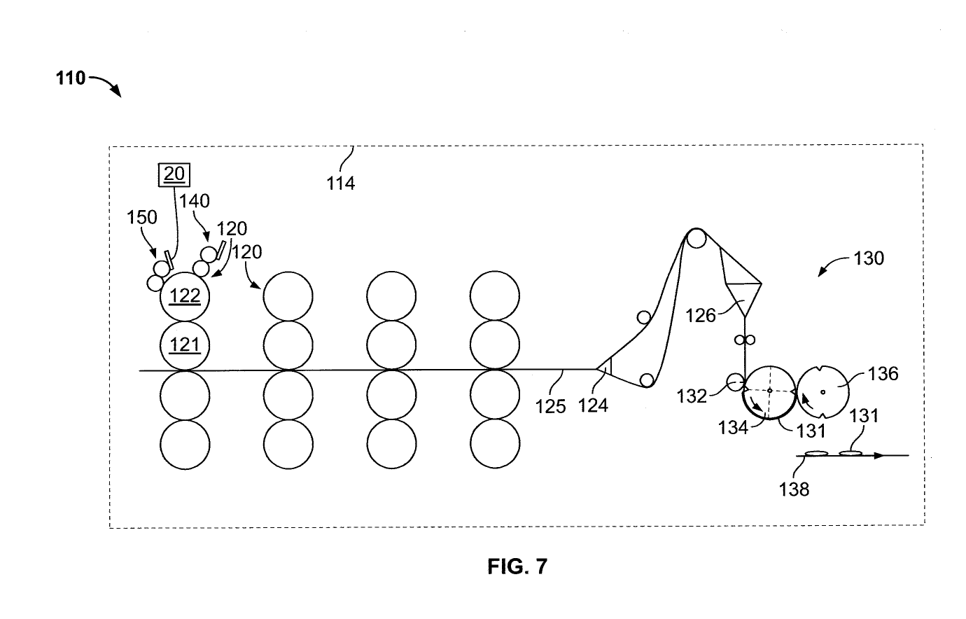

FIG. 7 shows a web offset, perfecting printing press including an inking apparatus 50 having an ink delivery 20 in accordance with the present invention. Printing press 110 includes a plurality of printing units 120 printing on a web 125. Each printing unit may include a plate cylinder 122 and blanket cylinder 121. Printing press 110 may be a variable cutoff printing press. Variable cutoff printing presses are able to a plurality of print jobs having a variety of cutoff lengths. In order to accommodate a variety of cutoff lengths, circumferences of plate and blanket cylinders may be varied, for example, blanket and plate cylinders of different sizes may be employed, existing cylinders may be packed or padded to increase their circumference, or printing plates and blankets having a variety of thicknesses may be interchanged. Each plate cylinder 122 includes a corresponding dampening apparatus 40 and a corresponding inking apparatus 50 for supplying a dampening solution and ink to plate cylinder 122.

After a web 125 is printed, web 125 may be split into a plurality of ribbons by a splitter 124 then folded in half longitudinally by a former 126. A folder 130 of press 110 may include a knife cylinder 132 for cutting web 125 into signatures 131, a collect cylinder 134 for gripping and collecting signatures 131 and a jaw cylinder 136 for folding a plurality of collected signatures 131 in half. A conveyor 138 may be provided to transport signatures 131 further downstream for further processing and/or delivery.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An ink delivery system comprising:
a closed or closable ink container holding an ink supply, the ink container having an inlet and outlet, the inlet and outlet arranged in the ink container to hold pressurized air when the ink container is closed and partially filled with ink;
an air delivery system supplying pressurized air to the ink container via the inlet;
a pump connected to the outlet of the ink container, the pump receiving ink from the ink container;
an ink fountain receiving ink from the pump.

2. The ink delivery system of claim 1, wherein the outlet is below a level of the ink when the ink container is partially filled with ink, and wherein the inlet is above the level of the ink when the ink container is partially filled with ink.

3. The ink delivery system as recited in claim 1, wherein the ink is ultraviolet or electron beam ink, and wherein the pressurized air is a low pressure air, said low pressure air being from about 5 pounds per square inch (PSI), to a maximum pressure, the maximum pressure being less than a pressure at which the ink cures.

4. The ink delivery system as recited in claim 1, wherein the ink is ultraviolet or electron beam ink, and wherein the pressurized air is low pressure air, said low pressure air being from 7 to 10 PSI.

5. The ink delivery system as recited in claim 1 wherein the pump is a peristaltic pump.

6. The ink delivery system as recited in claim 1 wherein the ink supply is ultraviolet ink or electron beam ink.

7. The ink delivery system as recited in claim 1, wherein the pump is connected to the ink fountain via a delivery tube, the delivery tube having an inner diameter of from about 10 to about 30 millimeters.

8. The ink delivery system as recited in claim 7 wherein the pump includes a peristaltic tube and a driven rotor, the driven rotor rotating at from about 5 to about 60 rotations per minute.

9. The ink delivery system as recited in claim 5 wherein the peristaltic pump includes a peristaltic tube and a driven rotor, the driven rotor rotating at from about 5 to about 60 rotations per minute.

10. A method for delivering ink comprising the steps of:
supplying ultraviolet or electron beam ink in a closed container, the closed container having an outlet below a level of the ink in the container, the closed container having a pressurized air inlet above the level of the ink;
pressurizing air in the closed container via the inlet so the ink flows into a pump; and
pumping the ink into an ink fountain.

11. The method as recited in claim 10, wherein the air is pressurized to a pressure which is from about 5 PSI, to a maximum pressure, the maximum pressure being less than a pressure at which the ink cures.

12. The method as recited in claim 10, wherein the air is pressurized to a pressure which is from 7 to 10 PSI.

13. The method as recited in claim 10 wherein the step of pumping includes pumping with a peristaltic pump.

14. The method as recited in claim 10, wherein the step of pumping includes pumping the ink to the ink fountain via a delivery tube having an inner diameter of from about 10 to about 30 millimeters.

15. The method as recited in claim 14 wherein the step of pumping includes pumping with the peristaltic pump, the peristaltic pump including a peristaltic tube and a driven rotor, the pumping including rotating the rotor at from about 5 to about 60 rotations per minute.

16. The method as recited in claim 13 wherein the peristaltic pump includes a peristaltic tube and a driven rotor, and the method comprises rotating the rotating at from about 5 to about 60 rotations per minute.

17. A printing press comprising:
a print unit printing a plurality of printed products; and
an ink delivery system as recited in claim 1.
